(19) United States
(12) Patent Application Publication
(10) Pub. No.: US 2015/0242681 A1
(43) Pub. Date: Aug. 27, 2015

(54) System and Method of Image Processing

(71) Applicant: LSI Corporation, San Jose, CA (US)

(72) Inventors: Pavel Aleksandrovich Aliseitchik, Moscow (RU); Denis Vladimirovich Zaytsev, Dzerzhinsky (RU); Denis Vasilyevich Parfenov, Moscow (RU); Aleksey Alexandrovich Letunovskiy, Moscow (RU); Dmitry Nicolaevich Babin, Moscow (RU)

(21) Appl. No.: 14/424,953

(22) PCT Filed: Apr. 16, 2013
(86) PCT No.: PCT/RU2013/000321

§ 371 Date: Feb. 27, 2015

(51) Int. Cl. G06K 9/00; G06T 1/60

(52) U.S. Cl. CPC G06K 9/00335; G06T 1/60; G06K 9/00973; G06K 2009/4666

(57) ABSTRACT

The disclosure is directed to a system and method of image processing. According to various embodiments of the disclosure, a storage module in communication with a plurality of memory banks stores a plurality of pixels of an image in the memory banks and interleaves the memory banks to enable a plurality of image scanners to access the plurality of pixels. A scanning module scans a selection of pixels in at least four directions relative to a first pixel of the plurality of pixels utilizing the plurality of image scanners. A singular points detection module in communication with the scanning module acquires a depth of each pixel of the selection of scanned pixels and determines a singularity value of the first pixel by comparing the depth of the first pixel with the depth of each pixel of the selection of pixels.

### FIELD OF INVENTION

The disclosure relates to the field of image processing and more particularly to image filtering at the pixel level.

### BACKGROUND

Image processing techniques are employed by many applications such as, but not limited to, gesture detection and recognition. In short-range applications, for example, fingers can be located to determine hand gestures performed by a user. Similarly, in long-range applications, images can be filtered to locate limbs to track or identify a user's body movements. In some applications, certain objects can be similarly tracked or identified by processing an image or a series of sequentially collected images. Improved image processing systems and techniques are needed to meet performance and precision requirements of modern applications.

### SUMMARY

An embodiment of the disclosure includes a system for image processing to locate portions of an image exhibiting high singularity (i.e. singular points) which are attributable to features such as, but not limited to, fingers, hands, feet, limbs, bodies, facial features, certain objects, or portions thereof. The system includes a storage module in communication with a plurality of memory banks. The storage module is configured to store image pixels in the memory banks and further configured to interleave the memory banks, thereby enabling a plurality of image scanners to access the image pixels in parallel. The system further includes a scanning module including the plurality of image scanners. The scanning module is configured to scan a selection of pixels in at least four directions relative to a first pixel utilizing the plurality of image scanners. The system further includes a singular points detection module configured to acquire a depth of each pixel of the selection of pixels scanned by the scanning module. The singular points detection module is further configured to determine a singularity value of the first pixel by comparing the depth of the first pixel with the depth of each pixel of the selection of pixels within a selected proximity of the first pixel.

It is to be understood that both the foregoing general description and the following detailed description are not necessarily restrictive of the disclosure. The accompanying drawings, which are incorporated in and constitute a part of the specification, illustrate embodiments of the disclosure.

### BRIEF DESCRIPTION OF THE DRAWINGS

The embodiments of the disclosure may be better understood by those skilled in the art by reference to the accompanying figures in which:

FIG. 1 is a block diagram illustrating a system for processing an image, in accordance with an embodiment of the disclosure;

FIG. 2 is a block diagram illustrating a storage module of the system, in accordance with an embodiment of the disclosure;

FIG. 3 illustrates at least a portion of an image defined by a plurality of image pixels, wherein the image pixels include at least one singular point, in accordance with an embodiment of the disclosure;

FIG. 4 illustrates at least a portion of an image defined by a plurality of image pixels, wherein image pixels are scanned in four directions relative to a first pixel, in accordance with an embodiment of the disclosure;

FIG. 5 is a block diagram illustrating system for recognizing gestures, in accordance with an embodiment of the disclosure; and

FIG. 6 is a flow diagram illustrating a method of processing an image to detect one or more singular points of the image, in accordance with an embodiment of the disclosure.

### DETAILED DESCRIPTION

Reference will now be made in detail to the embodiments disclosed, which are illustrated in the accompanying drawings.

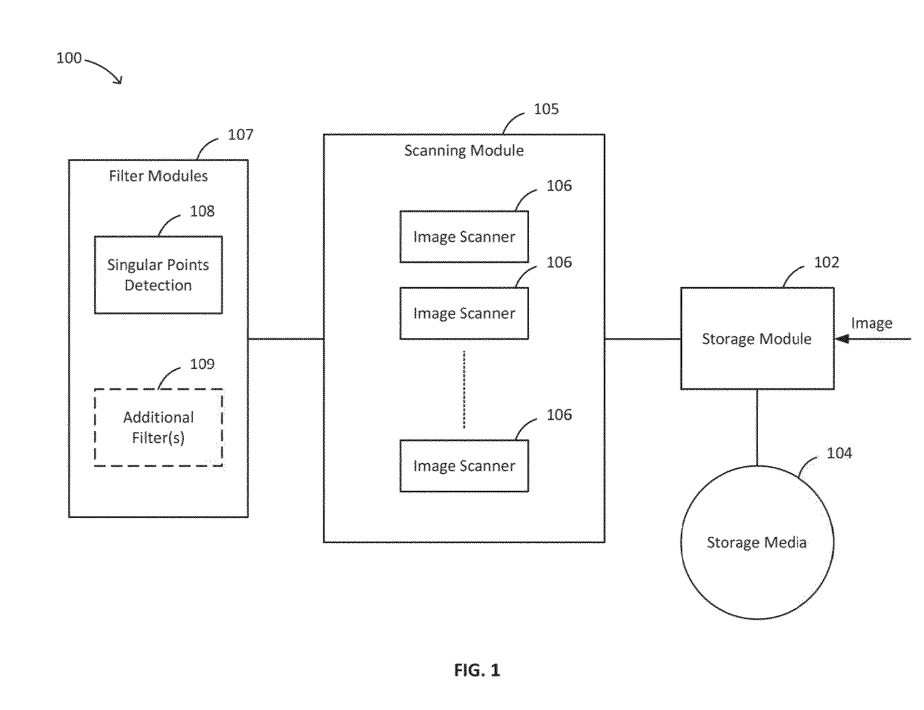

FIG. 1 illustrates an embodiment of a system 100 for processing at least one image to determine at least one image attribute or generate a filtered imaged. In some embodiments, an incoming image is processed to detect portions of the image exhibiting high singularity (i.e. “singular points”) which are attributable to features such as, but not limited to, fingers, hands, feet, facial features, limbs, bodies, objects, or portions thereof. In some embodiments, various features or portions of a feature are detected according to selected levels of singularity determined by the system 100 at one or more pixels of the image. In some embodiments, the system 100 is further configured for recognizing gestures based upon the location of one or more features detected in an image or tracked through a series of images.

The system 100 includes a plurality of modules including hardware, software, firmware, or any combination of the foregoing configured to execute various functions or steps described herein. In some embodiments, one or more of the various functions or steps are carried out by at least one processor, such as a single-core or multiple-core processor, executing program instructions from carrier or storage media. In some embodiments, a module further includes dedicated hardware such as, but not limited to, a microcontroller, ASIC, FPGA, electronic circuitry, or combinational logic configured to execute one or more of the various steps or functions described herein.

According to various embodiments, the system 100 includes a storage module 102 in communication with a scanning module 105. In some embodiments, the scanning module 105 includes a plurality of scanning sub-modules 106 (hereinafter “image scanners 106”), each configured to independently scan image pixels along a selected direction. The storage module 102 is configured to store image pixels on at least one storage medium 104. The storage module 102 is further configured to interleave memory banks storing the image pixels to enable the scanning module 105 to scan a selection of image pixels in a plurality of directions with two or more image scanners 106 operating in parallel. In some embodiments, the storage module 102 is configured to enable up to four image scanners 106 operating in parallel to scan the selection of image pixels in at least four directions relative to the first image pixel. In some embodiments, the scan directions include at least a vertical direction, a horizontal direction, and two diagonal directions allowing the scanning module 105 to scan a selection of pixels proximate to the first pixel. As used herein, the “first pixel” refers to any pixel of interest and is not limited to one pixel of the image.

The system 100 further includes one or more image filtering modules 107 in communication with the scanning module 105. In some embodiments, the filtering modules 107 include a singular points detection module 108 configured to determine singularity values for one or more image pixels. In some embodiments, the singular points detection module 108 is configured to determine a singularity value of one or more image pixels such as the first pixel by comparing depth of the first pixel with depth of each pixel of the selection of scanned pixels in proximity of the first pixel. In some embodiments, the singular points detection module 108 is further configured to determine a singularity value for each pixel of a plurality of image pixels iteratively processed by the scanning module 105 in a manner similar to the first pixel.

In some embodiments, the image filtering modules 107 include one or more image filters 109 instead of or in addition to the singular points detection module 108. Many additional filters 109 are known to the art such as, but not limited to, Gaussian, median, and bilateral filters. In some embodiments, the one or more image filtering modules 107 are configured to determine at least one attribute (e.g. singular points) of the image by processing scan data collected by the one or more image scanners 106 from the selection of scanned pixels. In some embodiments, the one or more image filtering modules 107 are additionally or alternatively configured to generate a filtered version of the image based upon the scan data.

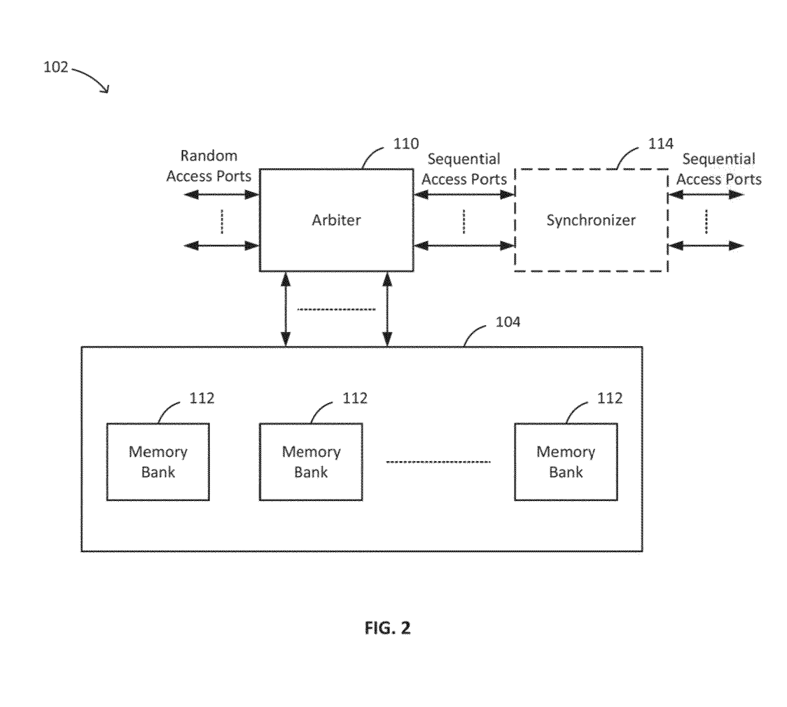

In an embodiment, illustrated in FIG. 2, the storage module 102 includes an arbiter 110 in communication with the plurality of memory banks 112 of the storage media 104. The arbiter 110 is configured to interleave the memory banks 112 to reduce memory access conflicts when a plurality of image scanners 106 of the scanning module 105 are operating in parallel to read image pixels or write resulting scan data back to memory. In some embodiments, the arbiter 110 is configured to interleave the memory banks 112 according to an interleaving technique described in Lin H., Wolf W. (2000). Co-Design of Interleaved Memory Systems. Proc. Int. Workshop Hardware/Software Codesign, San Diego, Calif., 46-50.

In some embodiments, the arbiter 110 is configured to resolve memory access conflicts utilizing a scheduling technique such as, but not limited to, a “round robin” conflict resolution technique. For example, a first image scanner 106 and a second image scanner 106 of the scanning module 105 may simultaneously request access to (same or different) pixels stored in a first memory bank 112. In some embodiments, the arbiter 110 is configured to provide the first image scanner 106 access to the first memory bank 112 while the second image scanner 106 remains idle. At a succeeding clock cycle, the first image scanner 106 moves to a completion state or requests image pixels from a second memory bank 112. The arbiter 110 is then configured to provide the second image scanner 106 access to the first memory bank, thereby allowing the first and second image scanners 106 to scan an image corresponding to the image pixels in parallel without memory access conflicts. In some embodiments, two or more image scanners 106 operating in parallel are further configured to scan the image in different directions by accessing the interleaved memory banks 112 via sequential access ports of the arbiter 110.

In some embodiments, the storage module 102 further includes a synchronizer 114 configured to synchronize memory access for two or more image scanners 106 to support various filters such as, but not limited to, Gaussian, median, or bilateral filters. The synchronized access allows the scanning module 105 to collect information about the selection of pixels proximate to (i.e. surrounding) the first pixel at the same clock cycle for each image scanner 106. In some embodiments, the synchronizer 114 is further configured to provide an indication (e.g. “pixels_done” output) when all scanners processing the image are finished scanning a first selection of pixels. Upon receiving the indication from the synchronizer 114, the image scanners 106 are configured to begin processing a second selection of pixels unless the image or a selected portion of the image has been completely processed. In some embodiments, the image scanners 106 are configured to substantially simultaneously move on to the second selection of pixels.

For short-range applications, the depth (i.e. distance to camera) value for each pixel of a corresponding image can be represented as an 8-bit value. Increasing internal bus width up to a selected software interface bus width (e.g. 32-bit width) can improve overall performance of the system 100. In some embodiments, the storage module 102 is thus configured to store four 8-bit depth values in each of a plurality of 32-bit memory banks 112 accessed via 32-bit buses. In long-range applications, the depth of each pixel can be represented by a greater number of bits (e.g. 16-bit value). In some embodiments, the storage module 102 is thus configured to store two 16-bit depth values in each of the plurality of 32-bit memory banks 112. The system 100 may employ any selected number of bits to represent the pixel depth values with wider buses and memory cells to improve performance.

In some embodiments, the image storage module 102 includes the following (Verilog) interface script or functionally equivalent code:

module gr_image
# (

| parameter | PIXEL_WIDTH = 32, | |
|---|---|---|
| parameter | X_MAX = 83, | |
| parameter | Y_MAX = 60, | |
| parameter | MEM_BANKS = 2, | |
| parameter | BANK_SIZE = 8192, | |
| parameter | ADDR_WIDTH = 13 | // log2 (BANK_SIZE) |

)
(

| input | [X_BITS*PORTS − 1 : 0] x, | |
|---|---|---|
| input | [Y_BITS*PORTS − 1 : 0] y, | |
| input | [PORTS − 1 : 0] write_en, | |
| input | [PIXEL_BITS*PORTS − 1 : 0] wdata, | |
| input | [PORTS − 1 : 0] read_en, | |
| output | [PIXEL_BITS*PORTS − 1 : 0] rdata, | |
| output | [PORTS − 1 : 0] grant, | |
| input | CLK, | // clock |

| | |
|---|---|
| input | RESET // reset |

);

The scanning module 105 is configured to scan image pixels on a pixel by pixel basis via access ports of the storage module 102. In some embodiments, the scan direction of one or more image scanners 106 of the scanning module 105 is configurable at runtime (e.g. by changing a “direction” input). Accordingly, pixels can be scanned in multiple directions utilizing the same image scanner 106 for different filters or for different stages of a filter. In some embodiments, the scanning module 105 further includes a first-in-first-out (FIFO) submodule configured to store a selected number of previously scanned pixels while additional pixels are being scanned. The FIFO submodule reduces the number of memory access conflicts when implementing filters with a large carrier because the previously scanned pixels are temporarily stored for access by a filter module, such as the singular points detection module 108. Accordingly, a number of scan directions required for processing each new pixel of interest is reduced (i.e. less scanner access to memory is required).

In some embodiments, the scanning module 105 and the storage module 102 include interfaces enabling the modules to be operatively chained in a pipeline such that a first stored image is scanned for processing by a first filter, a second stored image is scanned for processing by a second filter, and so on. In some embodiments, the scanning module 105 includes the following (Verilog) interface script or functionally equivalent code:

module gr_image_scanner

// interface between an image reader and the multi-port memory,

containing pixels

// can scan the image in horizontal, vertical, or diagonal directions

# (

| | |
|---|---|
| parameter PIXEL_WIDTH = 32, | // bits per pixel |
| parameter ADDR_WIDTH = 13 | // memory address width |
| parameter FIFO_DEPTH = 0 | // fifo depth |

)
(

| // external interface: | | |
|---|---|---|
| input | start, | // start the scan |
| input | [ADDR_WIDTH − 1 : 0] start_addr, | // start address |
| input | [ADDR_WIDTH − 1 : 0] steps, | // scan steps |

(specified on start)

| | | |
|---|---|---|
| input | go, | // continue the scan |
| input | [1 : 0] dir, | // scan direction 10 |

(--) , 01 (|), 11(\), 00 (/)

| | | |
|---|---|---|
| output | [PIXEL_WIDTH − 1 : 0] pixel, | // current pixel data |
| output | reg [COORD_WIDTH − 1 : 0] addr, | // current address |
| output | dva, | // pixel data valid |
| output | pixels_done, | // current pixels |

read

| | | |
|---|---|---|
| output | reg can_go, | // next pixel exists |
| output | done, | // scan done |

| // fifo information | |
|---|---|
| output | fifo_empty, |
| output | fifo_full, |
| output | [2 : 0] fifo_count, |
| output | [FIFO_DEPTH*PIXEL_WIDTH − 1 : 0] fifo_data // entire fifo |

data

| | |
|---|---|
| output | [PIXEL_WIDTH − 1 : 0] fifo_out, |
| output | [PIXEL_WIDTH − 1 : 0] fifo_in, |

. . .
);

In some embodiments, the singular points detection module 108 is configured to detect portions of the image exhibiting selected levels of singularity (i.e. singular points) that are attributable to features such as fingers or certain objects, among others. In some embodiments, the singular points detection module 108 is configured to detect a singular point at a first pixel having coordinates (X₀, Y₀) when for each pixel of a selection of 8 or more pixels surrounding the first pixel (in eight directions relative to the first pixel), there exists another pixel having coordinates (Xᵢ, Yᵢ) for which, according to Cartesian metrics:

(X₀−Xᵢ)²+(Y₀−Yᵢ)²≦R², and

Dᵢ−D₀≧H; or

according to Manhattan metrics:

|X₀−Xᵢ|+|Y₀−Yᵢ|≦R], and

Dᵢ−D₀≧H;

where R is a selected radius (in pixels), Dᵢ is a pixel depth (e.g. distance from the i^{th} point to a camera), and invalid pixels are assumed to have D=∞. Parameters R and H are selected according to the application. In short-range (e.g. ≦0.6 m) detection of fingers, for example, H=10 mm and R=5 are acceptable parameter values for normalized and original size images. In other embodiments, however, it is appreciated that alternative R and H values are likely required to conform to specification of a selected short-range or long-range application.

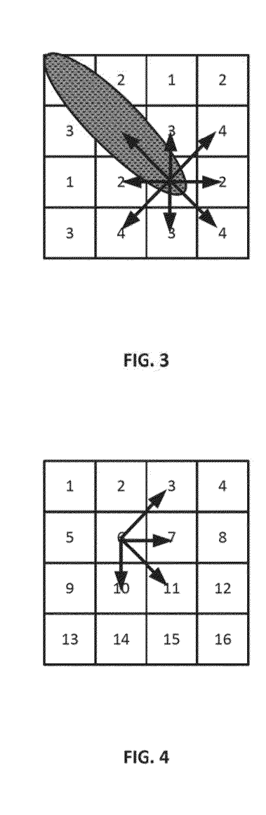

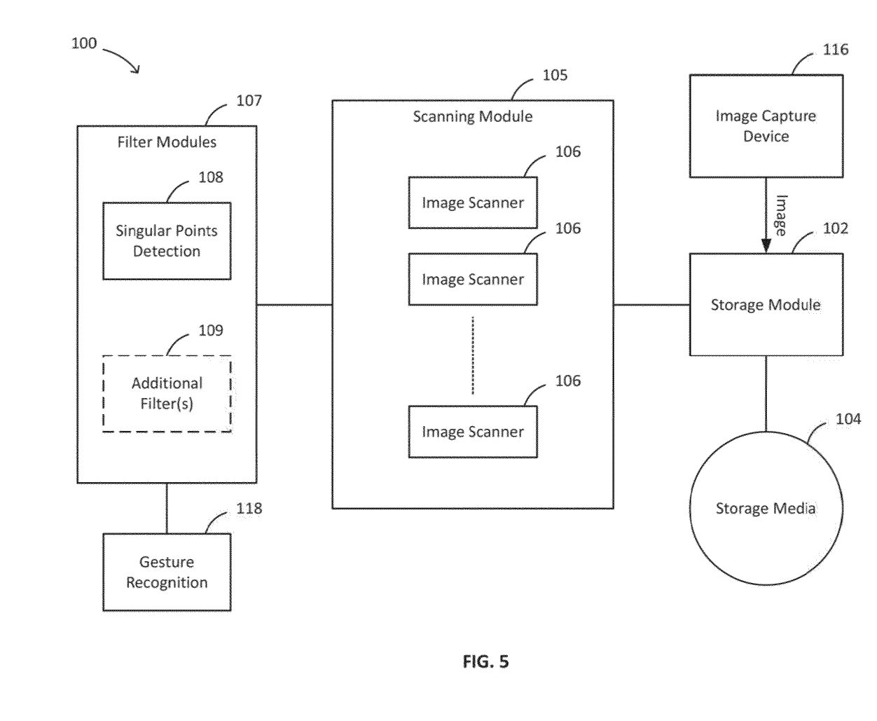

In some embodiments, the singular points detection module 108 is configured to determine a singularity value for each image pixel by comparing depth of each pixel with a selection of scanned pixels extending in a plurality of directions, as illustrated in FIG. 3. In some embodiments, the FIFO submodule of the scanning module 105 is configured to store enough pixels for comparing a first pixel with a selection of pixels surrounding the first pixel (i.e. in eight directions) with only four scan directions, as shown in FIG. 4. A second portion of the selection of pixels (from the other four directions relative to the first pixel) is stored by the FIFO submodule from previous scans. The FIFO submodule reduces processing time by enabling a four-pass scan (see FIG. 4) of the image rather than an 8-pass scan (see FIG. 3).

In some embodiments, up to four image scanners 106 operating in parallel are enabled to access image pixels in memory without conflicts, further improving processing speed. In some embodiments, a filter 108 or 109 is configured to access scan data according to a selected number of clock cycles such as, but not limited to, once every clock cycle or once every two cycles. In some embodiments, when scan data is accessed once every two or more clock cycles more than four image scanners 106 operating in parallel are enabled to access four memory banks 112 without conflicts. For example, FIG. 3 illustrates an embodiment where four memory banks are interleaved to allow for parallel access. In some embodiments, a greater number of image scanners 106 operating in parallel are supported utilizing a greater number of substantially simultaneously accessible memory banks (e.g. 16 interleaved memory banks shown in FIG. 4).

In some embodiments, the singular points detection module 108 is configured to execute the following steps at each clock cycle or at a selected number of clock cycles. The detection module 108 is configured to acquire a depth Dᵢₙ of a next (incoming) pixel in a current direction and a depth Dₒᵤₜ of a previous (outgoing) pixel stored by the FIFO submodule. The detection module 108 is further configured to determine a minimum depth Dₘᵢₙ and a maximum depth Dₘₐₓ of pixels stored by the FIFO submodule. The detection module 108 is further configured to: increase the singularity value of each pixel in the FIFO submodule for which Dᵢₙ−Dᵢ≧H, when Dᵢₙ−Dₘᵢₙ≧H; increase the singularity value of each pixel in the FIFO submodule for which Dₒᵤₜ−Dᵢ≧H, when Dₒᵤₜ−Dₘᵢₙ≧H; increase the singularity value of the incoming pixel, when Dₘₐₓ−Dᵢₙ≧H; and increase the singularity value of the outgoing pixel (from FIFO), when Dₘₐₓ−Dₒᵤₜ≧H.

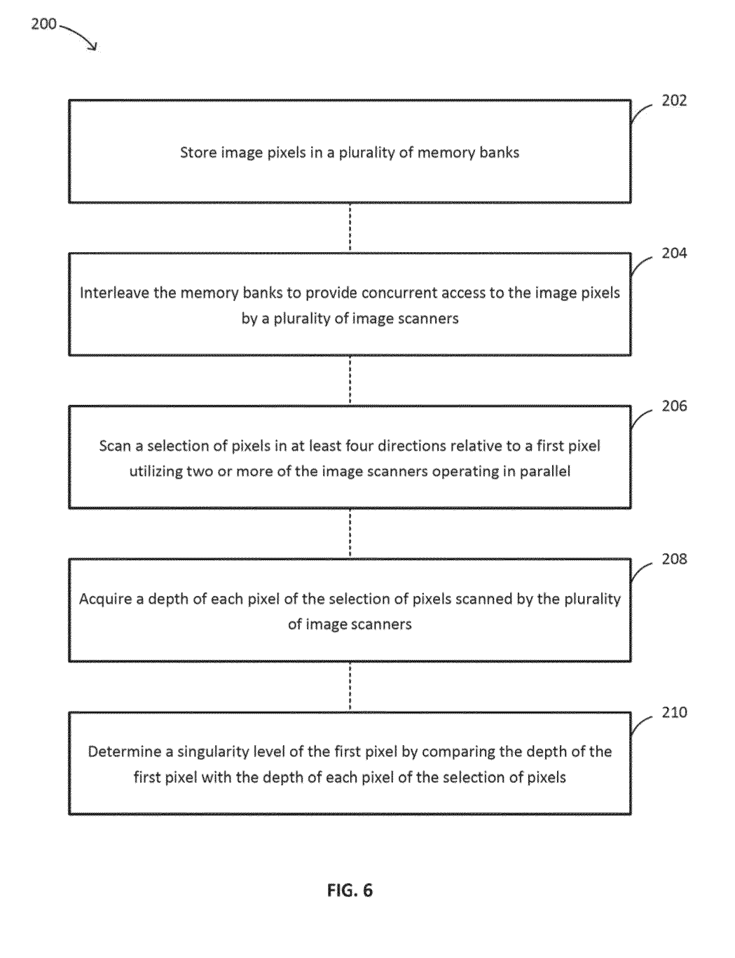

In some embodiments, the foregoing approach enables the steps illustrated in FIG. 6 (described below) to be implemented in a pipeline. At each clock cycle or selected number of clock cycles, the singularity level of one image pixel scanned by each of the operating image scanners 106 is increased. The singularity values of all scanned image pixels are accordingly determined after four scanning passes, one in each of the four directions. As previously discussed, the four passes can be performed by one, two, four, or more image scanners 106, depending on specified requirements or configurable settings.

The singular points detection module 108 is further configured to detect one or more singular points of the image based upon singularity values determined for the scanned pixels. As illustrated in FIG. 3, a feature with a high singularity value (e.g. 7 or 8, 8 being the highest possible value) may correspond to a finger or a fingertip, while low to medium singularity values (e.g. 4 to 6) may correspond to a hand or limb. It is appreciated that any feature or combination of features having variable dimensions can be detected by the foregoing system 100.

In some embodiments, illustrated in FIG. 5, the system 100 is further configured for gesture recognition. According to such embodiments, the system 100 further includes an image capture device 116 such as a camera or photo-detector and a gesture recognition module 118. The image capture device 116 is configured to collect one or more images and transfer the collected images to the storage module 102 to be stored by the storage media 104 for subsequent image processing. In some embodiments, the image capture device 116 is configured to sequentially capture a series of images for substantially “real-time” processing or according to a specified timing delay.

The gesture recognition module 118 is configured to detect various gestures based upon singular points detected in one or more images by the singular points detection module. In some embodiments, the gesture recognition module 118 is configured to detect a gesture based upon the location of at least one singular point in one image or based upon a plurality of locations tracked through a series of images. In some embodiments, the gesture recognition module 118 is further configured to associate one or more singular points with one or more features (e.g. fingers) and further configured to detect a gesture based upon the location of the one or more features within the image or a change in location tracked through a series of images. In some embodiments, the gesture recognition module 118 is further configured to associate a first set of one or more singular points with a first feature (e.g. finger) based upon a first singularity threshold and a second set of one or more singular points with a second feature (e.g. hand) based upon a second singularity threshold. The gesture recognition module 118 may accordingly detect gestures based upon a plurality of features located throughout an image or tracked through a series of images.

FIG. 6 is a flow diagram illustrating an embodiment of a method 200 image processing to detect singular points attributable to various features, as discussed above. System 100 is a manifestation of method 200 and all steps or functions described with regard to embodiments of system 100 or method 200 are applicable to both the system 100 and method 200. However, it is noted that one or more steps of method 200 may be executed via means known to the art beyond those described with regard to embodiments of system 100. Accordingly method 200 should be broadly construed to encompass any acceptable means for carrying out the steps described below.

At step 202, pixels corresponding to an image are stored in a plurality of memory banks. At step 204, the memory banks are interleaved to enable a plurality of image scanners operating in parallel to read the image pixels. At step 206, the image is scanned in at least four directions relative to a first pixel utilizing two or more image scanners operating in parallel. At steps 208 and 210, a depth value of the first pixel is compared against depth values corresponding to a selection of pixels proximate to the first pixel (e.g. all pixels within radius R). A singularity value is assigned to the first pixel based upon the comparison. The foregoing steps are further repeated as the image is scanned until singularity values are assigned to all pixels within the image or a selected portion of the image. In some embodiments, singular points attributable to various features are detected according to one or more threshold singularity values. In some embodiments, at least one gesture is detected utilizing information associated with the singular points such as the location of one or more singular points in an image or through a series of images.

It should be recognized that in some embodiments the various functions or steps described throughout the present disclosure may be carried out by any combination of hardware, software, or firmware. In some embodiments, various steps or functions are carried out by one or more of the following: electronic circuits, logic gates, field programmable gate arrays, multiplexers, or computing systems. A computing system may include, but is not limited to, a personal computing system, mainframe computing system, workstation, image computer, parallel processor, or any other device known in the art. In general, the term “computing system” is broadly defined to encompass any device having one or more processors, which execute instructions from a memory medium.

Program instructions implementing methods, such as those manifested by embodiments described herein, may be transmitted over or stored on carrier medium. The carrier medium may be a transmission medium, such as, but not limited to, a wire, cable, or wireless transmission link. The carrier medium may also include a storage medium such as, but not limited to, a read-only memory, a random access memory, a magnetic or optical disk, or a magnetic tape.

It is further contemplated that any embodiment of the disclosure manifested above as a system or method may include at least a portion of any other embodiment described herein. Those having skill in the art will appreciate that there are various embodiments by which systems and methods described herein can be effected, and that the implementation will vary with the context in which an embodiment of the disclosure deployed.

Furthermore, it is to be understood that the invention is defined by the appended claims. Although embodiments of this invention have been illustrated, it is apparent that various modifications may be made by those skilled in the art without departing from the scope and spirit of the disclosure.

What is claimed is:

1. A system for image processing, comprising:
a storage module in communication with a plurality of memory banks, the storage module configured to store a plurality of pixels of an image in the plurality of memory banks, and further configured to interleave the plurality of memory banks to enable a plurality of image scanners to access the plurality of pixels;
a scanning module including the plurality of image scanners, the scanning module configured to scan a selection of pixels in at least four directions relative to a first pixel of the plurality of pixels utilizing the plurality of image scanners; and
at least one filter module configured to receive scan data associated with the scanned selection of pixels from the scanning module, and further configured to determine at least one attribute of the image by processing the scan data.

2. The system of claim 1, wherein the at least four directions include a vertical direction, a horizontal direction, and two diagonal directions relative to the first pixel.

3. The system of claim 1, wherein the plurality of image scanners includes at least a first image scanner configured to scan a first portion of the selection of pixels in a first direction relative to the first pixel and a second image scanner configured to scan a second portion of the selection of pixels in a second direction relative to the first pixel.

4. The system of claim 3, wherein the first image scanner and the second image scanner are configured to operate in parallel.

5. The system of claim 1, wherein the at least one filter module includes a singular points detection module configured to acquire a depth of each pixel of the selection of pixels scanned by the scanning module, and further configured to determine a singularity value of the first pixel by comparing the depth of the first pixel with the depth of each pixel of the selection of pixels.

6. The system of claim 5, wherein the singular points detection module is further configured to locate one or more singular points of the image, each including at least one pixel with a singularity value above a selected singularity value.

7. The system of claim 6, further comprising:
a gesture recognition module configured to identify a gesture based upon the one or more singular points of the image located by the singular points detection module.

8. The system of claim 7, wherein the gesture recognition module is further configured to identify at least one feature based upon the one or more singular points of the image located by the singular points detection module, wherein the gesture is associated with the location of the at least one feature.

9. The system of claim 7, wherein the gesture recognition module is further configured to identify a first feature based upon one or more singular points located according to a first selected singularity value and a second feature based upon one or more singular points located according to a second selected singularity value.

10. A system for image processing, comprising:
a storage module configured to store a plurality of pixels of an image on at least one storage medium;
a scanning module configured to scan a selection of pixels in at least four directions relative to a first pixel of the plurality of pixels stored by the storage module; and
a singular points detection module configured to acquire a depth of each pixel of the selection of pixels scanned by the scanning module, further configured to determine a singularity value of the first pixel by comparing the depth of the first pixel with the depth of each pixel of the selection of pixels, and further configured to locate one or more singular points of the image, each including at least one pixel with a singularity value above a selected singularity value.

11. The system of claim 10, further comprising:
a gesture recognition module configured to identify a gesture based upon the one or more singular points of the image located by the singular points detection module.

12. The system of claim 11, wherein the gesture recognition module is further configured to identify at least one feature based upon the one or more singular points of the image located by the singular points detection module, wherein the gesture is associated with the location of the at least one feature.

13. The system of claim 11, wherein the gesture recognition module is further configured to identify a first feature based upon one or more singular points located according to a first selected singularity value and a second feature based upon one or more singular points located according to a second selected singularity value.

14. A method of image processing, comprising:
storing a plurality of pixels of an image in a plurality of memory banks;
interleaving the plurality of memory banks to enable a plurality of image scanners to access the plurality of pixels;
scanning a selection of pixels in at least four directions relative to a first pixel of the plurality of pixels utilizing the plurality of image scanners;
acquiring a depth of each pixel of the selection of pixels scanned by the plurality of image scanners; and
determining a singularity value of the first pixel by comparing the depth of the first pixel with the depth of each pixel of the selection of pixels.

15. The method of claim 14, wherein the at least four directions include a vertical direction, a horizontal direction, and two diagonal directions relative to the first pixel.

16. The method of claim 14, wherein scanning the selection of pixels includes:
scanning a first portion of the selection of pixels in a first direction relative to the first pixel utilizing a first image scanner; and
scanning a second portion of the selection of pixels in a second direction relative to the first pixel utilizing a second image scanner.

17. The method of claim 16, wherein the first image scanner and the second image scanner are operated in parallel.

18. The method of claim 14, further comprising:
locating one or more singular points of the image, each including at least one pixel with a singularity value above a selected singularity value; and
identifying a gesture based upon the one or more singular points of the image.

19. The method of claim 14, further comprising:
identifying at least one feature based upon the one or more singular points of the image, wherein the gesture is associated with the location of the at least one feature.

20. The method of claim 14, further comprising:
identifying a first feature based upon one or more singular points located according to a first selected singularity value; and
identifying a second feature based upon one or more singular points located according to a second selected singularity value.
